(19) United States
(12) Patent Application Publication
(10) Pub. No.: US 2013/0174479 A1
(43) Pub. Date: Jul. 11, 2013

(54) Plant Growing Cage

(71) Applicants: Barbara GERAGHTY, Martinez, CA (US); David GERAGHTY, Martinez, CA (US)

(72) Inventors: Barbara GERAGHTY, Martinez, CA (US); David GERAGHTY, Martinez, CA (US)

(21) Appl. No.: 13/734,553

(22) Filed: Jan. 4, 2013

Related U.S. Application Data
(60) Provisional application No. 61/583,494, filed on Jan. 5, 2012.

(51) Int. Cl. A01G 9/12

(52) U.S. Cl. CPC A01G 9/12
USPC 47/45

(57) ABSTRACT

Disclosed herein is a new tool for use in planting fruits and vegetables which under certain circumstances may increase the yield of fruit and vegetables. The tool is a structure that envelopes the plant and protects the lower portion of the plant by enclosing it in a structure that protects the plant from the elements and yet allows the plant to get the benefit of sunlight. A cage is disclosed having a lower portion enveloped in plastic or other suitable material. Certain opacities of plastics or other materials may be used according to local climate conditions and plant type.

### PRIORITY

This application claims the benefit of U.S. provisional patent application 61/583,494 entitled “Plant Growing Cage” filed on Jan. 5, 2012 by the same inventors which is incorporated by reference as if fully set forth herein.

### BACKGROUND

The present invention relates generally to garden tools, and more particularly to a device for increasing yield from fruit and vegetable bearing plants.

Every year millions of people plant vegetable gardens. The goal is to provide fresh home-grown vegetables along with enjoying the pleasure of gardening. One goal of most gardeners is to increase the yield of fruits and vegetables from their garden. For example and without limitation, conventional tomato cages are often inadequate. After planting, the young plant does not have sufficient support and would spread horizontally on the ground leaving much of the plant outside the cage and spoiled by being on the ground. This has been a universal problem for gardeners.

Accordingly an improved plant growing system is desired.

### SUMMARY

Disclosed herein is a new tool for use in planting fruits and vegetables which under certain circumstances may increase the yield of fruit and vegetables. The tool is a structure that envelopes the plant and protects the lower portion of the plant by enclosing it in a structure that protects the plant from the elements yet allows the plant to get the benefit of sunlight. A cage is disclosed having a lower portion enveloped in plastic or other suitable material. Certain opacities of plastics or other materials may be used according to local climate conditions and plant type.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 illustrates one embodiment of a plant growing device.

FIG. 2 shows another embodiment of a plant growing device.

### DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### DETAILED DESCRIPTION

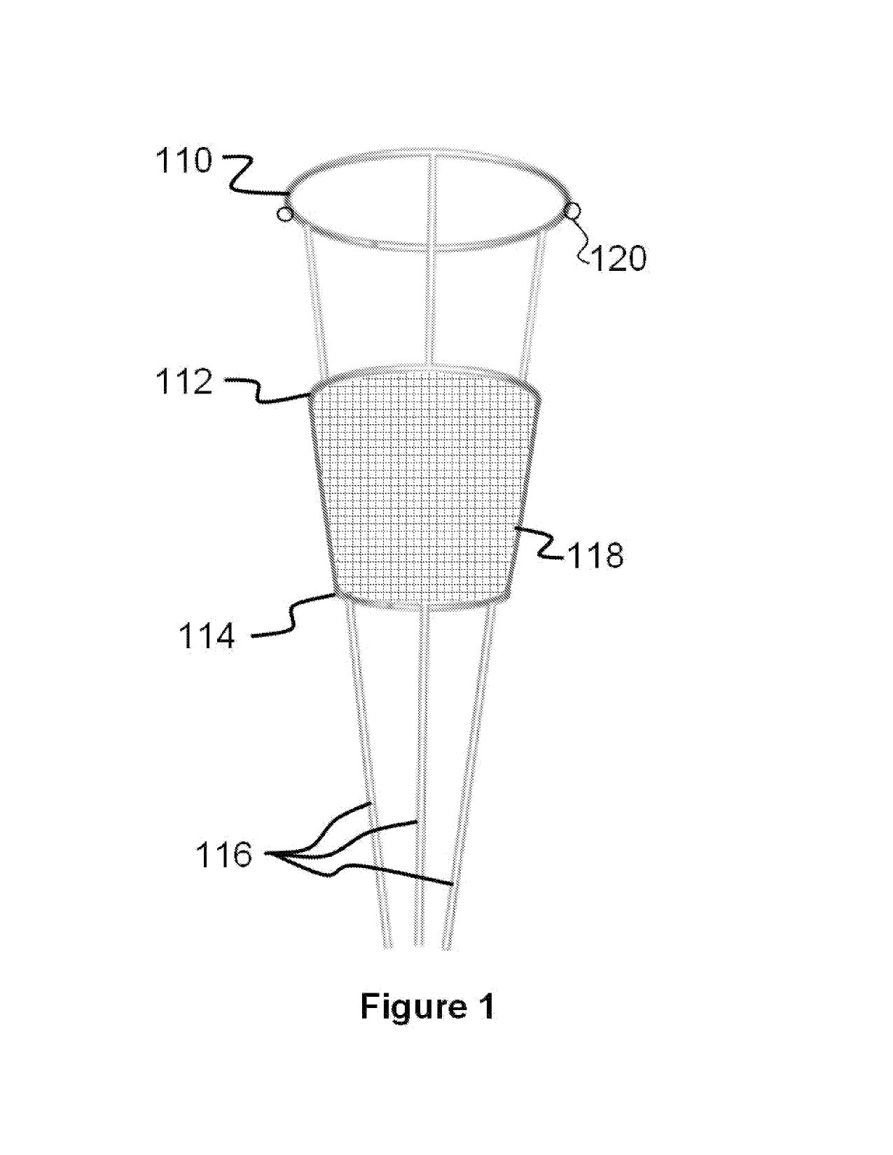

FIG. 1 illustrates an embodiment of a plant cage according to certain aspects of the current disclosure. In FIG. 1 a conventional style tomato cage may be made of wire, plastic or other suitable material capable of supporting the weight of the plant and enduring the weather and locate climate conditions. The cage may have multiple circular rings 110, 112 and 114 for holding a plurality of legs 116. The plurality of legs 116 are spaced about the rings 110, 112 and 114 to allow for supporting the ring generally horizontally so a plant may grow up through the ring. The legs 116 are generally thin enough to be easily disposed in the ground and sufficiently separated so encompass a plant or seedling. The leg spacing should be such that there is sufficient space to allow a plant to grow between the legs. Different leg structures, such as a fourth leg may be employed depending on the type of plant.

A wall 118 is formed using a plastic material mounted around the bottom of the cage. The inventor contemplates using a clear or opaque thin-walled plastic structure for the wall 118, but one having skill in the art may effect the wall using different material such as wire mesh. The inventors contemplate a wall with an approximate thickness of 20 mil, however other thicknesses and opacities may be employed to meet different growing needs and conditions. For example and without limitations colder climates may employ a thicker wall, whereas sunnier climates might employ a less translucent wall. By way of example only, the wall 118 guides the plant to a height of approximately 6 to 14 inches before the plant may spread out over the top of the wall 118. The wall 118 may be formed by wrapping and then fusing plastic to the wire on the lower portion of a round tomato cage so that when the cage is fully inserted into the ground the bottom of the plastic touches or almost touches the ground leaving the plastic at a predetermined height. The predetermined height may vary according to the type of plant and desired result. The wall 118 may also be formed by wrapping a thin sheet of plastic around the legs or by fastening separate panels about the legs.

The wall 118 may operate by causing a modified heat-sustaining, hot-house effect which makes the plant grow faster, larger and lusher. One or more o-rings or brackets 120 may be attached to the multiple circular rings 110, 112 and 114 or alternatively the legs 116. These rings 120 allow for the cages to be staked for support as the plants grow and become heavier. This provides an added convenience because support stakes can be easily inserted into the rings and driven into the ground without the usual inconvenience of having to use tie wire.

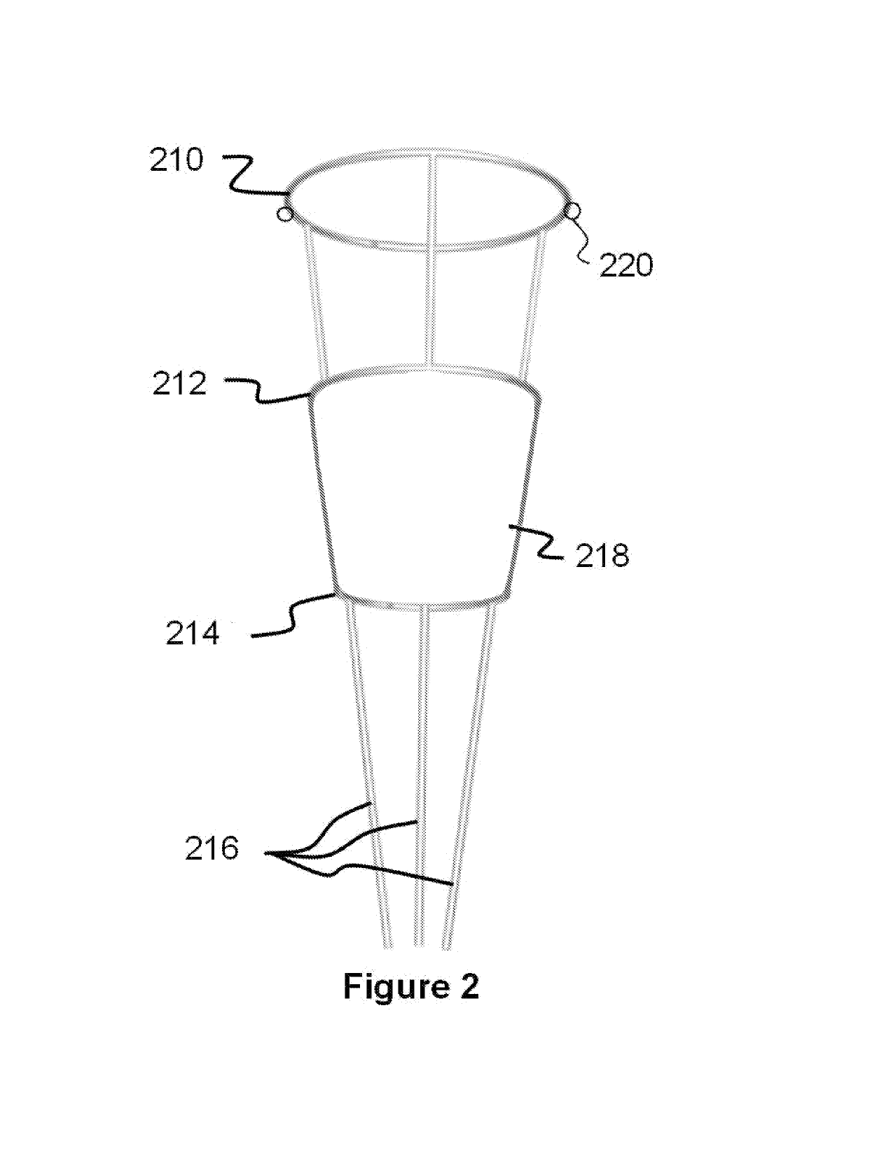

FIG. 2 shows another embodiment of a plant cage. In FIG. 2 three rings 210, 212 and 214 are supported by three legs 216. The rings are spaced apart having a first ring 210 at a top end of the legs 216. Opposite the top end of the legs 216, the legs 216 are unattached at a bottom end and are formed to allow the legs 216 to operate as stakes when the legs are set in the ground. The two remaining rings, 212 and 214, are positioned between the top and bottom end of the device creating a conventional plant cage. In some embodiments a retaining ring (or clip) 220 may be employed to allow for staking the plant cage to the ground.

Disposed between ring 212 and ring 214 is a barrier 218. The barrier 218 may be formed from plastic or other suitable material. The inventors contemplate using a relatively flexible plastic material having an element of opacity and a thickness in the range of 2 to 100 mil., however, this disclosure should not be limited to this material or thickness. In certain embodiments the barrier material may have a smooth surface on one side and a rough surface on the other. In some embodiments the barrier material may have at least one relatively reflective surface.

The lower end of the barrier 218 is secured about the ring 214 such that the barrier 218 is inside the perimeter formed by the rings 214. Similarly the upper end of the barrier 218 is secured about the ring 212 such that the barrier is inside the perimeter formed by ring 212. The barrier 218 may be positioned so the smooth surface is directed outwards while the rough surface is directed into the center of the circle formed by the rings 214 or 212. In the embodiment shown, the barrier 218 forms a portion of a cone (a frustum) having a hollow center. One having skill in the art will appreciate that the barrier may be formed to other shapes as well as a cone.

In operation a user places the device shown in FIG. 2 into the ground substantially burying the three leg portions such that the barrier 218 extends to the ground. The barrier 218, held by the ring 214, may operate to provide a ground level enclosure about the center of the ring 214. This may act to prevent infestation by certain pests such as snails. Moreover, the barrier 218 operates to protect the stem of any plant enclosed by the cage. For example and without limitation, while a young plant is growing within the confines of the barrier, the plant will be protected by wind, yet fully exposed to any overhead light. In addition the barrier may trap heat to prevent adverse affects from cool temperature.

The barrier 218 may be fastened to the rings 212 and 214 using any suitable fastening material. For example and without limitation, the barrier 218 may be fastened to the rings using foldable plastic tabs secured by an adhesive, screw or other fastener. In certain embodiments the barrier 218 may be aligned to be flush with the lower ring 214 to provide for a better enclosure against the ground during operation.

The embodiments disclosed herein have certain advantages: they guide the plant to a sufficient height inside the cage before it begins to spread out; they provide protection from wind while the plant is young and vulnerable, and using this device may promote rapid growth of the budding plant.

One having skill in the art will appreciate that benefits derived from the disclosed embodiments may be effectuated using different, but similar embodiments. For example and without limitation, a single-piece barrier may be effectuated having a portion of the barrier material embedded in the ground such that an enclosure for a plant is formed. The barrier may additionally have supporting structure to hold and support a plant growing within the barrier.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

We claim:

1. A device comprising:
three elongated supports, said supports disposed substantially equidistance about a top ring;
a second ring disposed to encompass the elongated supports;
a third ring disposed to encompass the elongate supports, said second ring disposed a predetermined distance from said second ring, and
a barrier having a first edge coupled to the second ring and a second edge coupled to the third ring, said barrier disposed within the volume encompassed by the second and third rings,
wherein a portion of each of the elongated supports extends away from the barrier opposite the top ring.

2. The device of claim 1 wherein the barrier is comprised of translucent plastic.

3. The device of claim 1 wherein the thickness of the barrier is from 2 to 100 mils.

4. The device of claim 1 wherein the barrier has a substantially smooth surface disposed against the second and third ring.

5. A device comprising:
a support structure, said support structure including at least one leg portion;
a substantially circular ring disposed on said support structure;
a barrier, said barrier having a first end affixed to said ring and substantially enclosing an area formed by the ring.

6. The device of claim 5 further including:
a second substantially circular ring,
wherein a second end of the barrier is affixed to the second ring.

7. The device of claim 6 wherein the barrier is disposed within the area formed by the circular ring and the second circular ring.

8. The device of claim 6 wherein the barrier forms a hollow frustum enclosing an area within the circular ring and the second circular ring.
